(19) United States
(12) Patent Application Publication
(10) Pub. No.: US 2007/0163125 A1
(43) Pub. Date: Jul. 19, 2007

(54) Handheld scraping tool

(76) Inventors: Justin Discoe, Windsor, CO (US); Kurt Van Ulmer, Denver, CO (US); Tyler Smith Cornaby, Gastonia, NC (US); Cheryl Stoughton Goff, Denver, CO (US); Jeremy Miller, Longmon, CO (US)

Correspondence Address: MARTIN & HENSON, P.C., 9250 W 5TH AVENUE, SUITE 200, LAKEWOOD, CO, 80226, US

(21) Appl. No.: 11/529,774

(22) Filed: Sep. 27, 2006

Related U.S. Application Data
(60) Provisional application No. 60/721,042, filed on Sep. 27, 2005.

(51) Int. Cl. B26B 3/00

(52) U.S. Cl. 30/169

(57) ABSTRACT

A handheld tool for removing soft material from an object includes a scoop portion supported by longitudinal handle portion. The scoop portion has a concave wall extending upwardly from a bottom to terminate in a rim edge. The rim edge may have a first edge portion on a first lateral side so as to form forming a first cutting edge with a first cutting characteristic, a second edge portion on a second lateral side so as to form forming a second cutting edge with a second cutting characteristic, and a third edge portion extending transversely of the longitudinal axis to form a third cutting edge. The scoop portion may be rotatably supported on the handle portion. The handle portion may have a proximal portion supporting the scoop and a flattened distal portion offset from the proximal portion. A transverse ridge may be located proximately to the scoop portion.

### BACKGROUND

Devices for scraping soft material have been used by humans for several million years. Early humans fashioned scraping devices from materials such as rock, bone, and shells. These early scraping devices were employed to remove blubber, animal fat, or fleshy material from skins in order to prepare the skins for tanning or other conditioning. As humans evolved, so to did the design of their scraping devices. Scrapers are now commonly used to facilitate removal of such substances as old paint, varnish, shellac, and the like. Furthermore, spoon-like utensils, spatulas, paddles, and the like, used for food preparation, may sometimes function as scraping devices.

Scoops and scraping devices generally include only one type of scraping edge, which requires the user to employ a second device of a second cutting edge when that need exists. Furthermore, scoops and scrapers generally have a fixed size and shape. Again, this requires the user to maintain a plurality of differently sized and configured scrapers for any given scooping project. An example of one such project is the preparation of a jack-o-lantern for Halloween. In preparing a jack-o-lantern a pumpkin is first scooped out to create a hollow orb. Once cleaned the pumpkin is carved with a scary face or monster.

Generally the cleaning of the pumpkin is accomplished with a spoon or scraper. Cleaning the innards of the pumpkin usually includes at least two steps. The first of which is clearing out the large debris and seeds from the interior. The second part of the cleaning process entails smoothing the inside of the pumpkin and thinning the walls of the pumpkin. Each of these steps benefits from a tool with a different size and cutting characteristic.

It is clear from the described pumpkin cleaning process, that multiple tools of various shapes and cutting capacities are currently needed for cleaning a pumpkin. Accordingly, there is a need for an improved handheld scraping tool that has versatile size and scraping characteristics. There is also a need for a handheld scraping tool that provides for an enhanced grip, especially where the material being scraped is slippery, such as the innards of a pumpkin.

### SUMMARY

Provided herein is a handheld scraping tool that addresses the need, as described above, for a handheld scraping tool with multiple cutting characteristics and scoop radii. In at least some of the embodiments described herein, the disclosed handheld tool includes a handle portion extending along a longitudinal axis, which is adapted to be gripped by a human hand. Supported on the handle portion is a scoop portion that has a concave wall extending upwardly from a bottom to terminate in a surrounding rim edge that defines a concavity for scooping. The rim edge includes a first edge portion that is located on a first lateral side of the longitudinal axis and defines a lateral cutting edge with a cutting characteristic in the form of a toothed edge. The rim edge also includes a second edge portion that is located on the second lateral side of the longitudinal axis opposite the first side. The second edge portion has a lateral cutting edge with a cutting characteristic that is different from the first cutting characteristic. Next, the rim edge includes a third edge portion, which extends transversely of longitudinal axis and defines a cutting edge at the forward end of the tool. The rim edge may optionally include a fourth edge portion, which also extends transversely of longitudinal axis in defining a fourth cutting edge at the second end of the scoop.

The rim edge may be oriented generally in a plane that is parallel and spaced above the longitudinal axis of the handle portion. The handle portion also includes a proximal portion, which supports the scoop portion and a distal portion that is flattened and acts as a grip for the user to engage with their hand. In this case a flattened handle portion may extend generally in a first plane. In this case, the rim edge would be oriented generally in a second plane that is spaced from and generally parallel to the first plane of the flattened handle portion. The handle portion may also include a proximal portion that includes an arcuate support arm for supporting the scoop portion. The handle portion may include an upstanding ridge extending upwardly from the handle portion and transversely of the longitudinal axis. The upstanding ridge is preferably located proximate to the scoop portion to act as a thumb stop to prevent the users thumb or finger from slipping into the rim edge, thereby preventing injury.

The cutting characteristics of the various rim edges may be of different configurations. For instance, the cutting or scraping edge may be a simple smooth edge or it may include triangular teeth. The triangular teeth may be of different sizes and shapes. For instance, the teeth may be triangular or, for example, formed as a continuous undulating edge. It should also be understood that the cutting edges may be of various combinations of smooth, triangular, and undulating edges, to name a few. The rim edge can be generally configured as an oval having a longitudinally oriented long axis. It should be understood however that the rim edge may be configured in various other geometric shapes.

It is contemplated that the scoop portion and handle portion be of an integrally molded one-piece construction. It is also contemplated that the handheld tool may include a scoop portion that is rotatably disposed on the handle. The rotatable scoop design may also include a spring operated detent operative to resist rotation of the scoop portion from at least one discreet angular position. The handle portion may include a contoured channel structure formed therein and a spring formed congruently with the shape of the channel structure in order to nest therein. A portion of the spring protrudes from the channel structure and acts as the detent, which engages multiple interdental positions formed in an aperture formed through the bottom of the scoop portion. The scoop portion is positioned about an upstanding post, which extends upwardly from the handle portion. The upstanding post would accordingly extend through the aperture formed in the bottom of the scoop portion. A fastener operative to retain the scoop portion on the post could be affixed to the post itself. The scoop portion may also be supported by a trunnion.

### BRIEF DESCRIPTION OF THE DRAWINGS

FIG. 1 is a perspective view illustrating a first embodiment of the handheld tool being used to clean out the innards of a pumpkin;

FIG. 2 is an enlarged perspective view of the handheld tool shown in FIG. 1;

FIG. 3 is a top plan view of the handheld tool shown in FIGS. 1 and 2;

FIG. 4 is a cross-sectional view of the handheld tool as shown in FIG. 3 taken about lines 44;

FIG. 5 is an exploded side view in elevation of the handheld tool shown in FIGS. 1-4;

FIG. 6 is a top plan view of the handle portion of the handheld tool as shown in FIGS. 1-5, enlarged to show the post and detent channel structure;

FIG. 7 is an enlarged top view of the proximal end of the handle portion as shown in FIG. 6, including a partial scoop portion to illustrate the operation of the detent mechanism;

FIG. 8 is an enlarged partial view of the handheld tool showing a first construction of the scoop portion;

FIG. 9 is an enlarged partial view of the handheld tool showing an alternative construction of the scoop portion;

FIG. 10A is a plan view of the handheld tool showing the rotatable scoop portion oriented at an angle of 0°;

FIG. 10B is a plan view of the handheld tool similar to FIG. 10A wherein the rotatable scoop portion is oriented at an angle of 30°;

FIG. 10C is a plan view similar to that of FIG. 10B where the rotatable scoop portion is shown oriented at an angle of 60°;

FIG. 10D is a plan view of the handheld tool with the rotatable scoop portion oriented at an angle of 90°;

FIG. 11 is a top plan view of a second embodiment of the handheld tool according to the present invention that is of a one-piece integrally molded design; and

FIG. 12 is a side view in elevation of the handheld tool shown in FIG. 11.

### DETAILED DESCRIPTION OF THE EXEMPLARY EMBODIMENTS

The present invention generally relates to a handheld scraping and scooping tool. The handheld tool disclosed herein, is particularly suited for cleaning a pumpkin in preparation for carving features into the pumpkin to create a jack-o-lantern. It should be appreciated that the handheld tool could be used in a variety of applications where soft material is to be scraped and removed, such as watermelons, squash, gourds, etc. Often, people desire to carve such fruits with decorative features, especially to commemorate festivities such as Halloween, Thanksgiving, and even the Fourth of July.

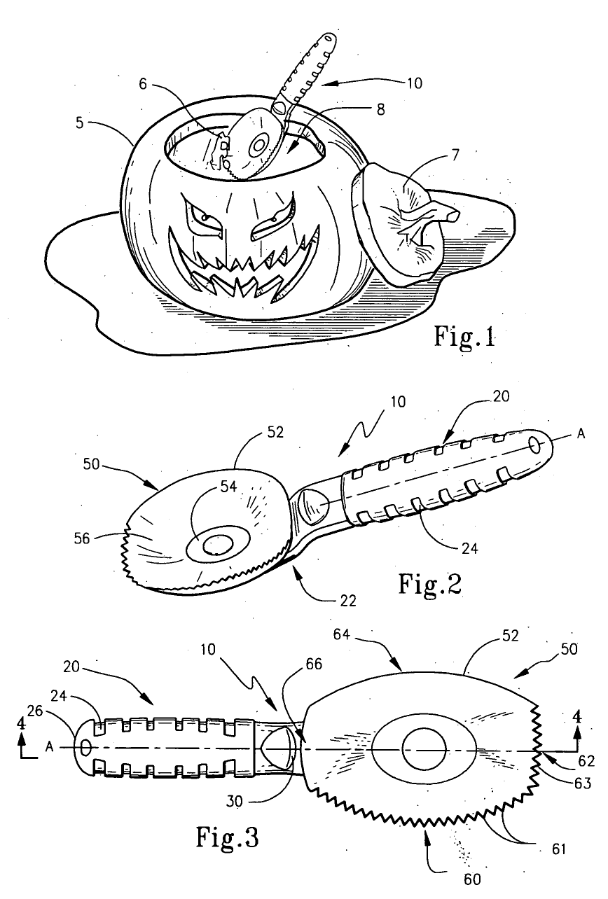

FIG. 1 illustrates handheld scoop 10 according to a first exemplary embodiment of the present invention being used to clean the innards 6 from pumpkin 5. Here, the handheld scoop 10 is being used to clean innards 6 out of the pumpkin 5 after a lid 7 and resulting opening 8 have been cut from the pumpkin 5.

As may be seen in FIG. 2, the handheld scoop 10 includes a handle portion 20, which extends along longitudinal axis “A”, and a scoop portion 50. The handle portion 20 includes a distal end portion 24, which forms the grip portion of the tool to be grasped by the users hand. Handle portion 20 also includes an arcuately shaped proximal end portion 22, which supports the scoop portion 50. The scoop portion 50 includes a concave wall 56, which extends upwardly from a flat bottom 54 to terminate in a surrounding rim edge 52.

As can be seen in FIG. 3, handle portion 20 may include an overmold 26 of soft grip material that is molded over distal end portion 24. Handle portion 20 may also include an upstanding ridge 30, which extends upwardly from the handle portion 20 and transversely of the longitudinal axis “A” wherein the ridge is located proximately to the scoop portion 50. Upstanding ridge 30 provides a curb or stop against which, the users thumb or forefinger can rest, thereby preventing the users finger from slipping into the rim edge 52.

As mentioned above, scoop portion 50 includes rim edge 52, which includes several edge portions. Here for example, a first edge portion 60 is located on a first lateral side of the longitudinal axis “A”. The first edge portion 60 has a cutting edge that is defined with a cutting characteristic in the form of a toothed edge having teeth 61. A second edge portion 64 is located on a second lateral side of the longitudinal axis, which is opposite the first edge portion 60 and, in this case, is defined by a second cutting edge configured to have a second cutting characteristic. Here the second cutting characteristic is that of a smooth edge configuration. A third edge portion 62 extends transversely of the longitudinal axis “A” to define a third cutting edge and in this case the third cutting edge is composed of a toothed edge formed by teeth 63 of a different size than the first teeth 61. Finally, the fourth edge portion 66 also extends transversely of longitudinal axis “A” and in this case is a smooth cutting edge.

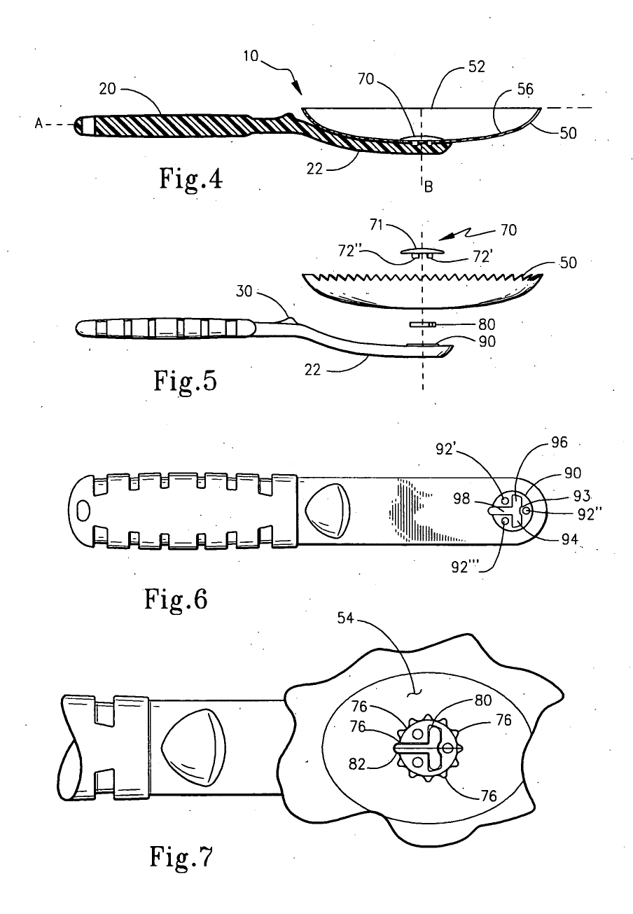

With specific reference to FIG. 4, it may be seen that scoop portion 50 is retained on proximal end portion 22 of the handle portion 20 with fastener 70. Rim edge 52 of the scoop portion 50 is oriented generally in a plane “P” parallel to and spaced from the longitudinal axis “A”. Also, scoop 50 rotates about an axis “B” that is generally perpendicular to axis “A”.

Referring now to FIG. 5, fastener 70 includes a disc-shaped base 71 and fastener posts 72′, 72″ and 72′″ (not shown). The exploded view of FIG. 5 also illustrates the relationship of the assembly components, wherein fastener 70 retains scoop portion 50 in position as well as capturing detent spring 80 in detent channel 93 described below.

As seen in FIG. 6, proximal end portion 22 includes an upstanding post 90 which includes a plurality of bores 92′, 92″ and 92′″ that are sized and configured to receive fastener posts 72′, 72”, and 72′″ of fastener 70. Formed in upstanding post 90 is a contoured detent channel 93. Contoured detent channel 93 in this case is a “T” shape formed of two laterally extending lobes 94 and 96 as well as longitudinally extending lobe 98.

FIG. 7 is a partial view of the assembled scoop portion with the fastener 70 removed to show the detent mechanism. Detent spring 80 is formed congruently with the detent channel 93 such that it nests therein. Note, however, that detent spring portion 82 protrudes beyond the nest 93 to act as a detent. Spring portion 82 is received into interdental spaces 76, which are formed in the perimeter of an opening in the bottom 54 of the scoop portion 50. Each interdental space 76 provides a different rotational position for scoop portion 50.

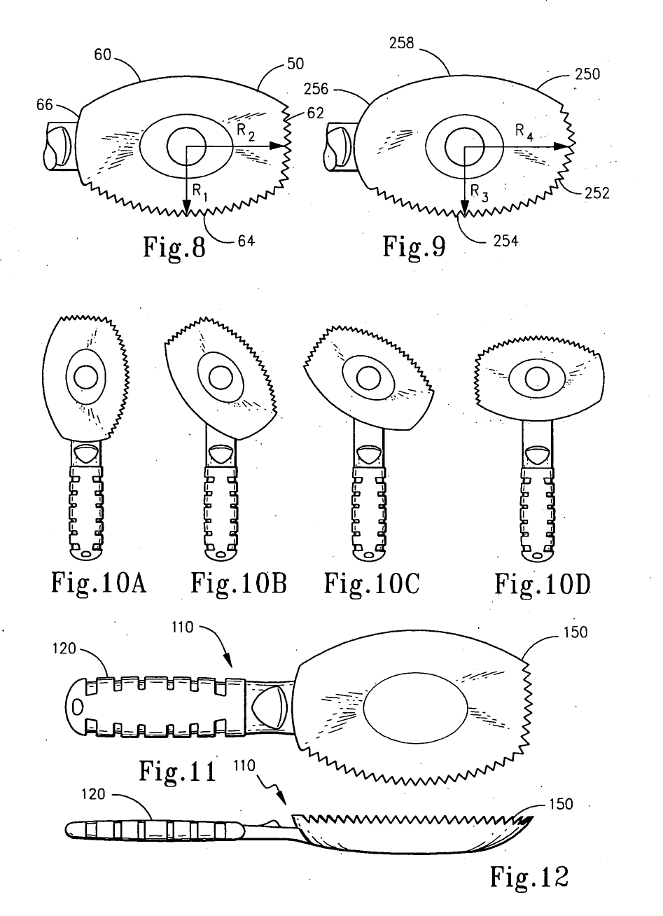

With reference to FIGS. 8 and 9 it may be seen that the scoop portion can be of a generally oval shape. As shown in FIG. 8, lateral edges 60 and 64 extend along a radius R₁. On the other hand lateral edge portions 62 and 66 extend along radius R₂ that is larger than R₁. FIG. 9 illustrates an alternative scoop design 250, which includes edge portions 252, 254, 256 and 258. Similar to the scoop portion shown in FIG. 8, scoop 250 has lateral edge portions, which extend along curves of radius R₃. However, in this case the lateral edge portions 252 and 256 extend along a radius of curvature, R₄ that is smaller than R₃. It should be noted that the radii R₁ and R₂ of FIG. 8 are selected such that the lateral edge portions 62 and 66 create ends that are squared and somewhat discontinuous with the lateral edge portions 64 and 60. On the other hand, FIG. 9 illustrates that the end portions 252 and 256 may extend along a radius of curvature R₄ that is smaller than that of R₂ creating rounded ends as shown in FIG. 9.

Turning now to FIGS. 10A-10D it can be seen that the scoop portion may be rotated to various angular positions. For instance, FIG. 10A illustrates the scoop portion oriented at 0° relative to the longitudinal axis “A”. Alternatively, FIG. 10B illustrates that the scoop portion has been oriented at 30°. FIG. 10C similarly shows that the scoop portion can be oriented at 60°. Finally, FIG. 10D shows the scoop portion rotated at a right angle or 90°. It should be understood that the scoop detent may be designed to orient the scoop portion at any desired angle. It should further be understood that the scoop may be rotated 360° in any increment desired.

Shown in FIGS. 11 and 12 is an alternative embodiment of the handheld scraping tool 110. In handheld scraping tool 110 the scoop portion 150 and the handle portion 120 are of integrally molded one-piece construction. It should be noted that the scoop portion 150 is constructed as is shown in FIG. 8. Alternatively the scoop portion 150 may be constructed as shown in FIG. 9. Although the exemplary embodiments have been described with some specificity with regard to certain features, the ordinarily skilled artisan will recognize that many of the described features may be changed from those shown in the exemplary embodiments. For example, the detent mechanism may be constructed in a variety of ways, the handle portion can be cylindrical in shape, the scoop portion could be retained on said handle portion with a trunnion, and the concavity of the scoop portion could be of a curvature different than that represented in the figures. Furthermore, the teeth included on the different scoop edge portions could be, as an example, rounded and the radii of curvature for the edge portions could be selected to create differently shaped edge rims.

Accordingly, the present invention has been described with some degree of particularity directed to the exemplary embodiments of the present invention. It should be appreciated, though, that the modifications or changes may be made to the exemplary embodiments of the present invention without departing from the inventive concepts contained herein.

I claim:

1. A hand-held tool adapted for use by a person in removing soft material from an object, comprising:
(A) a handle portion having a longitudinal axis and sized and adapted to be gripped by a human hand; and
(B) a scoop portion supported by said handle portion, said scoop portion having a concave wall extending upwardly from a bottom to terminate in a surrounding rim edge so as to define a concavity, said rim edge including
(1) a first edge portion located on a first lateral side of the longitudinal axis to define a first lateral cutting edge with a first cutting characteristic in the form of a toothed edge provided with a plurality of first cutting teeth,
(2) a second edge portion located on a second lateral side of the longitudinal axis opposite the first side to define a second lateral cutting edge with a second cuffing characteristic different from the first cutting characteristic, and
(3) a third edge portion extending transversely of the longitudinal axis to define a third cutting edge at a forward end of the tool.

2. A tool according to claim 1 wherein said rim edge is oriented generally in a plane parallel to and spaced above said longitudinal axis.

3. A tool according to claim 1 wherein said handle portion includes a proximal portion supporting said scoop portion and a distal portion that is flattened to extend generally in a first plane and which defines a grip to be engaged by the hand, said rim edge being oriented generally in a second plane that is spaced from and generally parallel to the first plane.

4. A tool according to claim 3 wherein said proximal portion includes an arcuate support arm that supports said scoop portion.

5. A tool according to claim 1 wherein said handle portion includes an upstanding ridge extending upwardly from said handle portion and transversely of the longitudinal axis, wherein said ridge is located proximate to said scoop portion.

6. A tool according to claim 1 wherein said handle portion and said scoop portion are of integrally molded one-piece construction.

7. A tool according to claim 1 wherein said second cutting edge characteristic is in the form of a smooth edge.

8. A tool according to claim 1 wherein said third cutting edge has a cutting characteristic the same as one of said first and second cutting edges.

9. A tool according to claim 1 wherein said third cutting edge has a cutting characteristic different from said first and second cutting edges.

10. A tool according to claim 9 wherein said third cutting edge is formed of third cutting teeth dimensioned differently from said first cutting teeth.

11. A tool according to claim 1 wherein said rim edge is generally configured as an oval having a longitudinally oriented long axis.

12. A tool according to claim 1 wherein said scoop portion is rotatably supported by said handle portion.

13. A tool according to claim 12 including a detent operative to resist rotation of said scoop portion from at least one discrete angular position.

14. A tool according to claim 13 wherein said detent is spring operated.

15. A tool according to claim 13 wherein said handle portion includes a contoured channel formed therein and a spring formed congruently with said channel, wherein a portion of said spring extends beyond said channel to define the detent.

16. A tool according to claim 12 wherein said scoop portion is positioned about an upstanding post extending upwardly from said handle portion.

17. A tool according to claim 16 wherein said post extends through an aperture formed through said bottom.

18. A tool according to claim 17 including a fastener operative to retain said scoop portion on said post.

19. A hand-held tool adapted for use by a person in removing soft material from an object, comprising:
(A) a handle portion extending along a generally longitudinal axis, said handle portion sized and adapted to be gripped by a human hand; and
(B) a scoop portion rotatably supported by said handle portion, said scoop portion having an exposed cutting edge.

20. A tool according to claim 19 wherein said handle portion includes a trunnion about which said scoop portion is supported.

21. A tool according to claim 20 wherein said scoop portion has a concave wall extending upwardly from a bottom to terminate in a surrounding rim edge so as to define a concavity.

22. A tool according to claim 21 wherein said bottom includes a hole having a perimeter sized to receive said trunnion with the perimeter having a plurality of interdental spaces formed therearound, said trunnion including a detent operative to engage at least one said interdental spaces.

23. A tool according to claim 22 wherein said rim edge is configured as an oval extending along a generally longitudinal scoop axis and where said rim edge includes
(A) a first edge portion located on a first lateral side of the scoop axis to define a first lateral cutting edge with a first cutting characteristic in the form of a toothed edge provided with a plurality of cutting teeth;
(B) a second edge portion located on a second lateral side of the scoop axis opposite the first side to define a second lateral cutting edge with a second cutting characteristic different from the first cutting characteristic;
(C) a third edge portion extending transversely of the scoop axis to define a third cutting edge at a first end of the scoop; and
(D) a fourth edge portion extending transversely of the longitudinal axis to define a fourth cutting edge at a second end of the scoop.

24. A tool according to claim 22 wherein said detent is spring operated.

25. A tool according to claim 19 wherein said handle portion extends along a generally longitudinal axis and said rim edge being generally oriented in a plane that is spaced from and generally parallel to the axis.

26. A tool according to claim 19 wherein said scoop portion is rotatable about an axis that is generally perpendicular to said longitudinal axis.
